(19) United States
(12) Patent Application Publication
(10) Pub. No.: US 2020/0175084 A1
(43) Pub. Date: Jun. 4, 2020

(54) INCORPORATING CONTEXTUAL INFORMATION IN LARGE-SCALE PERSONALIZED FOLLOW RECOMMENDATIONS

(71) Applicant: Microsoft Technology Licensing, LLC, Redmond, WA (US)

(72) Inventors: Andrew Hatch, Oakland, CA (US); Sami Ghoche, San Francisco, CA (US); Ankan Saha, San Francisco, CA (US)

(21) Appl. No.: 16/206,893

(22) Filed: Nov. 30, 2018

(51) Int. Cl. G06F 16/9536; H04L 12/58; G06K 9/62; G06F 17/18; G06N 20/00

(52) U.S. Cl. CPC G06F 16/9536; H04L 51/32; G06N 20/00; G06F 17/18; G06K 9/6265

(57) ABSTRACT

Disclosed herein are techniques for generating contextual follow recommendations. Consistent with embodiments of the present invention, for each of several specific contexts—for example, a member opts to follow another specific member—a set of contextual follow recommendations are pre-computed. Then, in real time, when follow recommendations are being presented to the member, the recommendation system will first make a determination as to whether a member has taken action consistent with any particular context, and if so, a set of pre-computed contextual follow recommendations will be retrieved for possible presentation to the member.

### RELATED APPLICATIONS

The present application is related to U.S. application Ser. No. 16/156,114, with title, “Techniques for Improving Downstream Utility in Making Follow Recommendations”, filed on Oct. 10, 2018, which is hereby incorporated herein by reference in its entirety.

### TECHNICAL FIELD

The present application generally relates to computer technology for addressing technical challenges in making follow recommendations—that is, recommendations relating to entities (e.g., people, companies, topics, etc.) that are, or are otherwise associated with, sources of content in which an end-user might be interested. More specifically, the present application relates to techniques, using machine learning models, for making follow recommendations that are influenced by real-time contextual information.

### BACKGROUND

With many online systems, such as online social networking services, blogging sites, video- and photo-sharing sites, marketplaces, and other content publishing platforms, end-users consume content (e.g., read articles and stories, view pictures and videos, shop for items, etc.) that has been generated and/or shared by other end-users. In many instances, the content that is presented to any particular end-user is selected for presentation to the end-user as a result of the end-user having elected to “follow” an entity (e.g., person, company, channel, or topic) associated with the content. To “follow” an entity is akin to subscribing to a content source, such that, when content is published by or on behalf of the entity, the subscriber (e.g., follower) becomes eligible to view the published content. The published content may be presented to the follower via any of a number of content publishing applications, such as the feed, or news feed, of a social networking service.

As an example, with many social networking services, end-users (often referred to as members) elect to follow other end-users. As illustrated in FIG. 1A, and by way of example, a portion of a member profile 100 of a member (“Bill Greats”) of a social networking service is presented. As shown with reference 102, a button with the label, “FOLLOW”, is presented with the portion of the member profile. The viewing member—that is the member to whom the follow button 102 has been presented—can elect to follow the member whose profile is being presented (e.g., “Bill Greats”) by simply selecting the follow button 102. Subsequent to the viewing member selecting the follow button for the member, Bill Greats, the viewing member may be presented with content that is published or shared by the member, Bill Greats. As an example, if Bill Greats publishes a blog posting, the member following Bill Greats may be notified of the blog posting via a content item presented in a feed, such that the blog posting is accessible via the content item presented in the feed.

As illustrated in FIG. 1B, the result of a member following a set of entities can be presented as a directed graph 104. In this simplified example, “User X” is following another member, “User A”, a company, “Company B”, and a topic, “Topic C”. The directed edges of the graph that connect User X with the various other entities are referred to as follow edges 106 and provide a type of content access privilege. By following Company B, User X has the privilege to receive content that is published on behalf of Company B. Similarly, by following Topic C, User X has expressed an interest in receiving any content that might be classified as being relevant or related to Topic C.

This concept of following is prevalent in many other online systems beyond those related to social networking services. As an example, many video sharing sites provide for the ability to follow a content channel to receive and view content being published in connection with the channel. Similarly, online marketplaces provide the ability to follow sellers, product brands, and/or categories of products, and so forth, as a mechanism by which to provide a potential buyer with the ability to express his or her shopping preferences and/or interests.

Generating follow recommendations for millions of end-users is a computationally complex and time-consuming task. Accordingly, with many online systems, follow recommendations are pre-computed offline on some periodic basis (e.g., daily or nightly, every few days, weekly, and so forth). One significant problem with this approach is that, by pre-computing the follow recommendations, an end-user's most recent activity does not influence the follow recommendations. For example, if follow recommendations are pre-computed at time, T=1, and then pre-computed again at time, T=5, any information about the end-user's activity that occurred between the time, T=1 and T=5 can be considered in pre-computing follow recommendations for a time subsequent to time, T=5. However, because the follow recommendations are pre-computed at time, T=1, any information obtained about the end-user's activity at time, T=2, 3 or 4, will not be factored into the pre-computed follow recommendations that are derived at time, T=1. Accordingly, if an end-user interacts with various content items at time, T=2, this information is not factored into any follow recommendations that may be presented to the end-user at time, T=3, because the follow recommendations are pre-computed at time, T=1.

### BRIEF DESCRIPTION OF THE DRAWINGS

Embodiments of the present invention are illustrated by way of example and not limitation in the figures of the accompanying drawings, in which:

FIG. 1A is a user interface diagram showing an example of a portion of a member profile along with a follow button, for a social networking service, consistent with embodiments of the present invention;

FIG. 1B is a diagram showing an example of a directed graph that represents the results of an end-user electing to follow various entities represented in a social networking service, consistent with embodiments of the present invention;

FIG. 2 is a simple timing diagram showing an example of how offline follow recommendations are pre-computed, while contextual follow recommendations are partially pre-computed, but dependent upon real-time contextual events, consistent with some embodiments of the present invention;

FIG. 3 is a block diagram showing the functional components of a social networking service or system, including a data processing module referred to herein as a follow recommendation engine, which is comprised of online and offline components, for use in generating and presenting follow recommendations, consistent with some embodiments of the present invention.;

FIG. 4 is a block diagram showing the functional components of a follow recommendation engine, for generating offline and contextual follow recommendations, consistent with some embodiments of the present invention;

FIG. 5 is a flow diagram illustrating a method of obtaining training data and learning, via machine-learning techniques, a scoring model for scoring follow recommendations for members of a social networking service, consistent with embodiments of the present invention.

FIG. 6 is a flow diagram illustrating a method, performed offline, of scoring follow recommendations on a per member basis, using machine-learned scoring models, consistent with embodiments of the invention;

FIG. 7 is a flow diagram illustrating a method, performed online or in real-time, for ranking and presenting follow recommendations, including both offline follow recommendations and contextual follow recommendations, responsive to a request and consistent with embodiments of the present invention;

FIG. 8 is a user interface diagram showing an example of a set of top ranked follow recommendations, including contextual follow recommendations, being presented to a member who has taken an action consistent with a particular context; and

FIG. 9 is a system diagram illustrating an example of a computing device with which, embodiments of the present invention might be implemented.

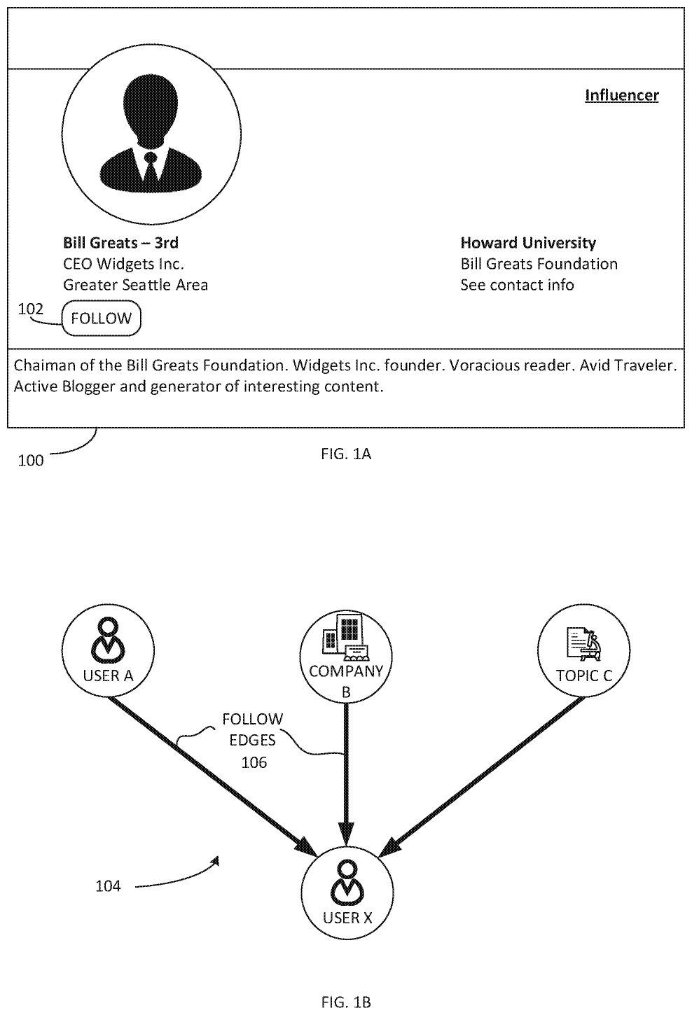

### DETAILED DESCRIPTION

Described herein are methods, systems and computer program products to facilitate the generation and presentation of follow recommendations such that the follow recommendations are conditioned on various forms of real-time contextual information (e.g., entities that the viewer has recently followed or browsed in the current browsinglviewing session, or topics with which the viewer has interacted.) Various embodiments of the present invention are set forth below in detail. It will be evident, however, to one skilled in the art, that the present invention may be practiced or implemented with varying combinations of the many detailed aspects set forth below, and in some instances, without each and every specific detail set forth herein.

A variety of techniques exist for generating follow recommendations in the context of online systems. With many online systems—particularly those with extremely large numbers of end-users follow recommendations are generated offline (e.g., pre-computed) on some periodic basis (e.g., daily) due to the complexity and required processing time. Accordingly, the follow recommendations that are generated for a particular end-user may depend upon a variety of factors, but as far as an end-user's activities (e.g., interactions with various content) are concerned, the recommendation algorithms are limited to using the activities of that end-user leading up to the time when the follow recommendations are pre-computed. As such, because follow recommendations are pre-computed on a periodic basis, the follow recommendations will not be influenced by any action that the end-user takes (e.g., content viewed, etc.) subsequent to when the follow recommendations were last pre-computed. The obvious disadvantage of this approach is that an end-user may not receive quality follow recommendations based on his most recent activity, which, in many instances, is the strongest signal of the end-user's interests. Moreover, research has shown that many end-users tend to “binge” follow—that is, many end-users tend to select many content sources to follow in short succession, e.g., during the same browsing/viewing session. Therefore, in many instances, batch pre-computing of follow recommendations, by itself, may not provide the best end-user experience.

Consistent with embodiments of the present invention, both offline follow recommendations and real-time contextual follow recommendations are utilized to provide a better end-user experience. Accordingly, a first set of offline follow recommendations are pre-computed and stored in an offline database. For purposes of the present disclosure, offline follow recommendations are those that are pre-computed offline, without the benefit of any real-time contextual information. The phrase or term, “offline follow recommendation(s)” is used to distinguish those follow recommendations generated without the benefit of some real-time contextual information from those follow recommendations that are influenced by real-time contextual information, which are referred to herein as “contextual follow recommendations.” For a particular browsing/viewing session for a given end-user, a particular context may or may not arise. Accordingly, having both offline follow recommendations and contextual follow recommendations allows the online system to provide meaningful follow recommendations, regardless of whether or not a particular context has materialized during an end-user's browsing/viewing session.

Consistent with embodiments of the invention, in addition to pre-computing offline follow recommendations, contextual follow recommendations are generated based on a combination of real-time and pre-computational operations. By way of example, with some embodiments, information relating to an end-user's most recent browsing activity is obtained and then used in combination with information that has been pre-computed offline, with resource intensive and computationally expensive operations. As a consequence, the contextual follow recommendations that are presented to an end-user can be dynamically adjusted and adapted to the behavior of the particular end-user in real time, providing for deeply insightful follow recommendations.

With some embodiments, using various machine learning techniques, features are pre-computed for each individual context that may materialize. By way of example, a context may be the act of following a specific entity (e.g., member, company or topic), or, browsing, navigating to, or viewing a particular entity's profile page. For each of these contexts, contextual follow recommendation candidates are identified along with their corresponding features, or sets of features, that are based on graph computations and other resource intensive computations. The various features for each contextual follow recommendation are combined and scored using one or more machine-learned scoring models, such that a final score for each contextual follow recommendation is computed by combining the various sub-scores generated by each scoring model, using each set of features. Finally, after pre-computing a score for each of several follow recommendations for a given context, the resulting follow recommendations and corresponding scores are written to a contextual database, keyed by their particular context. Here again, the phrase or term, “contextual database”, where contextual follow recommendations are stored, is used to simply differentiate from the offline database, where offline follow recommendations are stored. In any particular implementation, these databases may be separate and distinct, or the same.

Finally, in real time (e.g., during an end-user's browsing/viewing session), when a request is received to provide a set of follow recommendations for a particular end-user, the offline database is queried to get a first set of scored offline follow recommendations for the particular end-user. For instance, the set of scored offline follow recommendations includes some number of entities to be recommended to the end-user, along with corresponding scores. In addition, a context check is performed to determine whether any relevant contextual events may have occurred during some period of time immediately leading up to the request for follow recommendations. A context check may involve querying a database using some identifier for the particular end-user (e.g., a member identifier). If the particular end-user has just recently taken an action consistent with some contextual event (e.g., followed a particular person, company or topic, or, viewed the profile of a particular person, company or topic), the queried database will return a list of the context identifiers that identify the relevant contexts. The context identifiers are then used to query the contextual database for the relevant context, to get a set of scored follow recommendations relevant for the end-user and context. Finally, the set of scored offline follow recommendations and the set of scored contextual follow recommendations are processed to combine the various sub-scores of each follow recommendation, and to generate a single set of most relevant (e.g., highest scoring) follow recommendations, some subset of which are provided to the requesting application or service for presentation to the end-user. In a scenario where the context check does not result in any relevant contexts being returned for the particular end-user—e.g., meaning the end-user has not just recently taken any action consistent with a relevant contextual event—the set of follow recommendations returned to the requesting application or service are selected from the offline follow recommendations.

Consistent with some embodiments, the final score assigned to an offline follow recommendation candidate may be determined by combining sub-scores that result from individual machine-learned scoring models, taking as input different sets of features. By way of example, with some embodiments, a first set of features may relate to the viewer (e.g., the person to whom a follow recommendation is to be presented), a second set of features may relate to the follow recommendation candidate (e.g., the entity being recommended), while a third set of features may relate to the pair—that is, the combination of the viewer and follow recommendation candidate. Furthermore, with some embodiments, the final score assigned to an offline follow recommendation may be derived to represent both a likelihood that the viewer will opt to follow the entity being recommended when presented with a follow recommendation, and some metric representative of the level of engagement that the viewer is likely to have with content published by, or on behalf of, the entity being recommended. Accordingly, at least with some embodiments, the offline follow recommendation score assigned to each offline follow recommendation candidate is based on a combination of sub-scores, where each sub-score is itself determined by combining sub-scores determined using the aforementioned feature sets and various machine-learned scoring models.

Similarly, the contextual follow recommendation scores are determined by combining sub-scores, where each sub-score may be derived using different feature sets and different machine-learned scoring models. With some embodiments, the final score assigned to a contextual follow recommendation candidate may be based on a combination of sub-scores that are determined using features, or feature sets, that are specific to a machine-learned model for generating contextual follow recommendations, and sub-scores that are determined using the aforementioned features, or feature sets, that are specific to a machine-learned model for generating offline contextual follow recommendations.

Because an entity may be the subject of a follow recommendation that is included in the set of offline follow recommendations AND in the set of contextual follow recommendations, with some embodiments, the various sub-scores that result from the scoring models are combined in a manner so as not to double count scores for an entity that is included in both sets of follow recommendations. With some embodiments, the various sub-scores for a follow candidate are stored, without combining the sub-scores into a final score, thereby allowing for the sub-scores to be combined in real time to arrive at a final score. Accordingly, if a particular follow recommendation candidate appears in the set of offline follow recommendation candidates and the contextual follow recommendation candidates, the sub-scores for the candidate can be combined in a manner to ensure that the sub-scores are not counted twice. Moreover, by making the sub-scores available to the real time processing flow, certain of the sub-scores can be computed once, and used for determining the final score for both offline follow recommendation candidates and contextual follow recommendation candidates. This reduces the number of database calls that are required to obtain all of the relevant scores for the combination of offline and contextual follow recommendations, thereby increasing the speed at which recommendations can be made and improving the overall end-user experience. Other aspects of the present invention will be readily ascertainable from the description of the figures that follows.

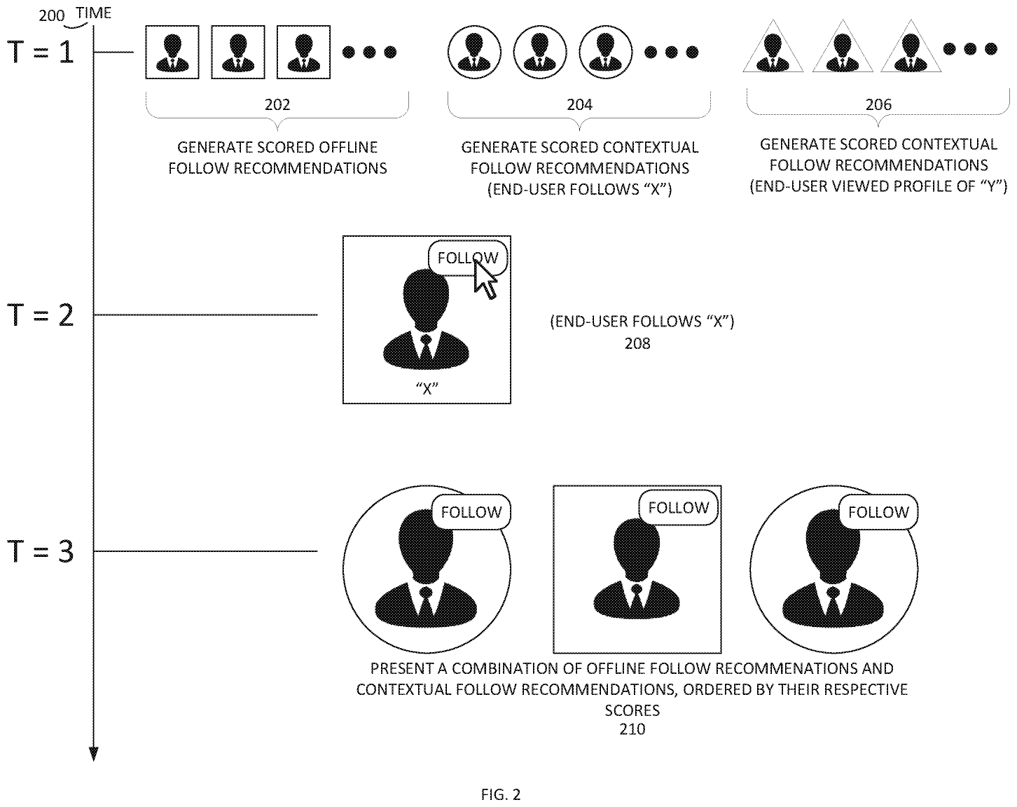

FIG. 2 is a simple timing diagram showing an example of how offline follow recommendations are pre-computed, while contextual follow recommendations are partially pre-computed but dependent upon real-time events, consistent with some embodiments of the present invention. As shown in FIG. 2, the line with reference number 200 represents a timeline, where separate events are shown to occur at times, T=1, T=2 and T=3. For example, at time, T=1, as shown with reference 202, a first set of offline follow recommendations are generated for a particular end-user. More precisely, for the particular end-user, a first set of offline follow recommendation candidates are identified, and then scored using one or more machine-learned scoring models. The offline follow recommendation candidates are identified and scored without consideration for any particular context—that is, their respective scores are independent of the particular end-user taking any specific action, such as, following another end-user, or, viewing the profile of a particular end-user, or company. Once pre-computed, the follow recommendation candidates and associated scores are then stored in a database for subsequent recall, where the data is stored, using as a key, a member or end-user identifier of the viewing end-user (e.g. the person to whom the follow recommendation is to be presented).

Similarly, as shown with reference number 204, at time, T=1, a second set of follow recommendations are generated for the particular end-user. This second set of follow recommendations are contextual follow recommendations, where the particular context is the “end-user follows ‘X’”. Accordingly, the contextual follow recommendations are to be presented to the end-user in the scenario where the end-user satisfies the contextual event—in this case, opts to follow another end-user designated here as “X”. The contextual follow recommendations are scored using one or more machine-learned scoring models, which have been trained by observing end-user behavior when presented with a follow recommendation for end-user, “X”.

Finally, as shown in FIG. 2, at time, T=1, a third set of follow recommendations are pre-computed for the particular end-user. This third set of contextual follow recommendations is dependent upon the contextual event, “end-user viewed profile of ‘Y’”. Accordingly, if the end-user views the profile of member, “Y”, during a browsing/viewing session, thereby satisfying the conditional contextual event, contextual follow recommendations from this third set may be presented to the end-user. In this overly simplified example, only two sets of contextual follow recommendations are identified and scored. However, in various embodiments, contextual follow recommendations of various types and for many more specific contexts, beyond those presented here, may be pre-computed and made available in the contextual database.

At time, T=2, and with reference number 206, the particular end-user, during a browsing/viewing session, opts to follow end-user, “X”. For example, when presented with a follow recommendation for the end-user, “X”, the particular end-user decides to follow “X” and selects the follow button presented with the recommendation. At time, T=3, follow recommendations are presented to the particular end-user. With some embodiments, after an end-user opts to follow an entity, a subsequent user interface is presented with additional follow recommendations that may be of interest to the end-user. Alternatively, the follow recommendations may be presented to the particular end-user as a result of the end-user taking some other action, as well. In any case, at T=3, the end-user is presented with follow recommendations that are ordered based on their respective scores. In this instance, because the particular end-user followed end-user “X” at time, T=2, the follow recommendation candidates associated with the contextual event for following “X” are included as candidates for presentation to the particular end-user, along with offline follow recommendations. The contextual follow recommendations associated with the contextual event of viewing the profile of “Y” are not included as candidates in this instance, because the particular end-user did not take any action consistent with the contextual event that is, the end-user did not view the profile of member, “Y”. As shown with reference number 210, two follow recommendations are presented to the particular end-user—one follow recommendation selected from the offline follow recommendation candidates 202, and two follow recommendations selected from the contextual follow recommendations candidates associated with the contextual event of following end-user “X”. With some embodiments, the number of follower recommendations presented, and the order in which the follow recommendations are presented, is dependent upon their respective scores, which are described in greater detail below.

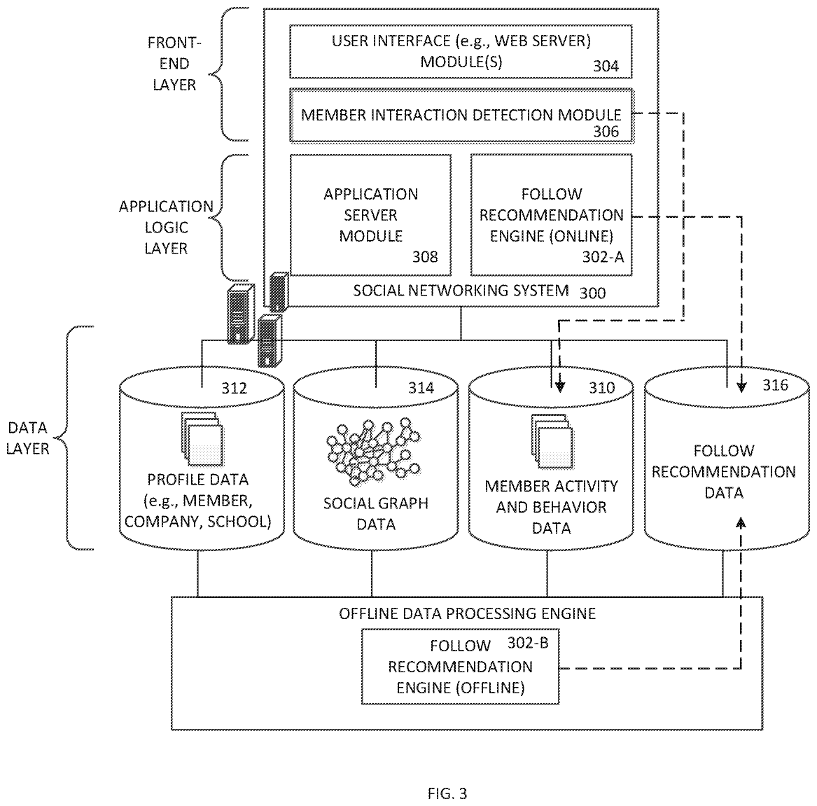

FIG. 3 is a block diagram showing the functional components of a social networking service or system 300, including a data processing module referred to herein as a follow recommendation engine, which, in this example, is comprised of online 302-A and offline 302-B components, for use in generating and presenting follow recommendations, consistent with some embodiments of the present invention. As shown in FIG. 3, the social networking system 300 is implemented with a three-layered architecture, generally consisting of a front-end layer, an application logic layer and a data layer. Of course, in other embodiments, different architectures may be used.

The front-end layer may comprise a user interface module (e.g., a web server) 304, which receives requests from various client computing devices and communicates appropriate responses to the requesting client devices. For example, the user interface module(s) 304 may receive requests in the form of Hypertext Transfer Protocol (HTTP) requests or other web-based API requests. In addition, a member interaction detection module 306 may be provided to detect various interactions that members have with different applications, services, and content presented. As shown in FIG. 3, upon detecting a particular interaction, the member interaction detection module 306 logs the interaction, including the type of interaction and any metadata relating to the interaction, in a member activity and behavior database 310.

The application logic layer may include one or more various application server modules 308, which, in conjunction with the user interface module(s) 302, generate various user interfaces (e.g., web pages) with data retrieved from various data sources in the data layer. Consistent with some embodiments, individual application server modules 308 are used to implement the functionality associated with various applications and/or services provided by the social networking system 300.

As shown in FIG. 3, the data layer may include several databases, such as a profile database 312 for storing profile data, including both member profile data and profile data for various organizations (es., companies, schools, etc.). Consistent with some embodiments, when a person initially registers to become a member of the social networking service, the person will be prompted to provide some information, such as his or her name, age (e.g., birthdate), gender, interests, contact information, home town, address, spouse's and/or family members' names, educational background (e.g., schools, majors, matriculation and/or graduation dates, etc.), employment history, skills, professional organizations, and so on. This information is stored, for example, in the profile database 312. Once registered, a member may invite other members, or be invited by other members, to connect via the social networking service. A “connection” may constitute a bilateral agreement by the members, such that both members acknowledge the establishment of the connection. Similarly, in some embodiments, a member may elect to “follow” another member. In contrast to establishing a connection, the concept of following another member is a unilateral operation and, at least in some embodiments, does not require acknowledgement or approval by the member that is being followed. When one member follows another, the member who is following may receive content published by the member being followed, or the member may receive updates or notifications relating to various activities undertaken by the member being followed. Similarly, when a member follows an organization, the member becomes eligible to receive content published on behalf of the organization. For example, content published on behalf of an organization that a member is following will appear in the member's personalized feed, sometimes referred to as a news feed, activity stream or content stream. In any case, the various associations and relationships that the members establish with other members, or with other entities and objects, are stored and maintained within a social graph in a social graph database 314, as shown in FIG. 3.

As members interact with the various applications, services, and content made available via the social networking system 300, the members' interactions and behavior (e.g., content viewed, links or buttons selected, messages responded to, etc.) may be tracked, and information concerning the members' activities, interactions and behavior may be logged or stored, for example, as indicated in FIG. 3, by the member activity and behavior database 310. This logged activity information may then be used by the follow recommendation engine 302 to generate follow recommendations for a member.

As shown in FIG. 3, the offline data processing engine comprises a framework for distributed storage and processing of extremely large data sets. In one example, the offline data processing engine may be implemented using Hadoop®, the Hadoop Distributed File System (HDFS™) and the MapReduce programming model. Of course, any of a number of other alternative frameworks might also be used. The offline portion of the follow recommendation engine 302-B obtains data from the data layer, and then processes the data to generate one or more machine-learned scoring models, for use in predicting the likelihood that a member will, when presented with a particular follow recommendation, elect to follow the entity being recommended thereby resulting in a new follow edge. Additionally, the offline portion of the follow recommendation engine 302-B may generate additional machine-learned scoring models for use in predicting the likelihood that a member will, having elected to follow a recommended entity, engage with content published by, or on behalf of, the recommended entity, in some time period immediately subsequent to the formation of the new follow edge. Finally, the offline portion of the follow recommendation engine 302-B will obtain data from the data layer, and then processes the data to generate various machine-learned scoring models, for use in predicting the likelihood that a member will opt to select a follow recommendation having just previously taken some action consistent with a contextual event.

With the various machine-learned scoring models having been generated, the offline portion of the follow recommendation engine 302-B will periodically perform a batch computation to generate for each member in a set of members, a set of offline follow recommendations with corresponding offline follow recommendation scores. For example, given a particular member, using some broad heuristics, a set of follow recommendation candidates is first determined for the particular member. As an example, the broad heuristic may be an entity score—that is, a score based on features of the entity being recommended. Accordingly, the offline follow recommendation candidates may be determined based on how many members are already following the entity being recommended. For each follow recommendation candidate in the set, a follow recommendation score is calculated by providing to the machine-learned scoring models various combinations of feature sets, and then combining the resulting sub-scores that result from the respective scoring operations. Alternatively, with some embodiments, the individual sub-scores are stored for subsequent recall and combination during run time. Accordingly, for each member in the set of members, the result is some set of scored follow recommendation candidates stored as follow recommendation data, for example, by the database with reference number 316.

Similarly, the offline portion of the follow recommendation engine 302-B will periodically perform a batch computation to generate for each member in a set of members, a set of contextual follow recommendations with corresponding contextual follow recommendation scores. Like the offline follow recommendations, the contextual follow recommendations (e.g., candidates, corresponding scores and context identifier) are stored in a database 316 for subsequent recall.

Upon receiving a request for follow recommendations for a particular member, the online portion of the follow recommendation engine 302-A will perform a series of operations to retrieve, rank/order, and provide follow recommendations to a requesting application or service for ultimate presentation to a viewing end-user. Accordingly, when the online portion of the follow recommendation engine 302-A receives a request for follow recommendations, for a particular viewing end-user, the follow recommendation engine will query the database for a set of offline follow recommendations. Additionally, the follow recommendation engine will determine whether the viewing user has recently taken any actions consistent with any contextual events that are associated with contextual follow recommendations. As an example, the follow recommendation engine may query a service that keeps track of contextual events for end-users. The service may reply with information (e.g., context identifiers) identifying various contexts that are relevant for the particular end-user. This information (e.g., the context identifiers) may be passed along to the database 316 along with information identifying the end-user in order to retrieve one or more sets of contextual follow recommendations that correspond with the context identifiers. Finally, with some embodiments, the offline follow recommendations and the contextual follow recommendations are processed to determine their final follow recommendations scores, such that some number of the highest scoring follow recommendations can be returned to the requesting application or service. As will be described in greater detail below, the output of the various machine-learned scoring models may be some set of sub-scores that are associated with individual follow recommendations. With some embodiments, these sub-scores may be combined in real time—that is, responsive to the request for follow recommendations for a Given end-user—to arrive at a final score for each follow recommendation candidate. This allows for the ability to re-use a sub-score that is specific to an entity—for example, derived based on some set of features that are specific to the entity being recommended—in both offline follow recommendations and contextual follow recommendations.

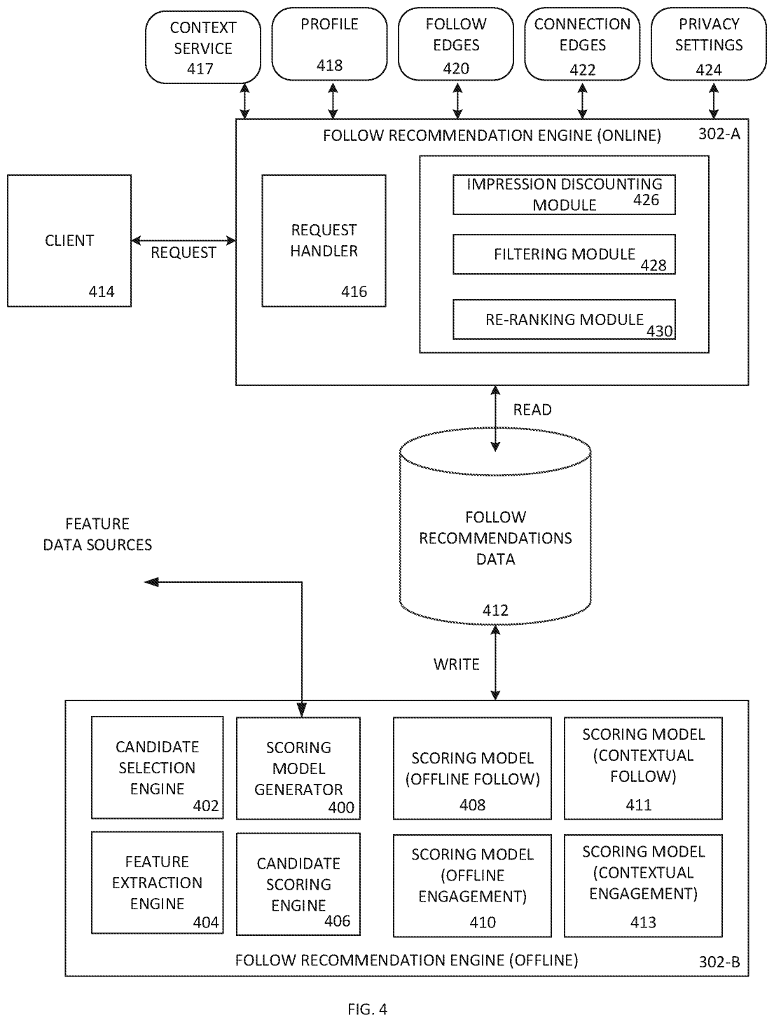

FIG. 4 is a block diagram showing the functional components of a follow recommendation engine (e.g., 302-A and 302-B), for generating offline and contextual follow recommendations, consistent with some embodiments of the present invention. In general, the inventive process for generating follow recommendations can be thought of as occurring in three phases. During the first phase, machine-learned scoring models are generated with training data obtained by presenting follow recommendations to some randomly selected set of members, and then observing the responses. During the second phase, using the machine-learned scoring models generated in the first phase, for each member in some set of members, a set of offline follow recommendations and corresponding follow recommendation scores are generated and stored. In addition, using one or more machine-learned models that have been specifically trained to predict the likelihood that a member will opt to follow an entity after the member has taken some action consistent with a contextual event, a set of contextual follow recommendations consistent with the contextual event are identified and scored. For example, a set of contextual follow recommendations may be pre-computed for presentation to a viewing member, if the member follows another specific member, the intuition in this instance being that if a member follows member “W”, the viewing member is highly likely to follow one of members “X”, “Y”, or “Z”, based on previously observed action of other members. This of course, is determined by making a statistically significant number of observations as to the outcome of presenting certain follow recommendations to members, and observing their collective responses in order to train a relevant scoring model for making subsequent predictions. By tracking various features associated with members, recommended entities, and member-recommendation pairs, a model can be trained to predict the likelihood that a member will opt to follow a recommended entity, given that the member has just recently taken some action—e.g., followed another member, or, viewed the profile of another member. Accordingly, for any number of contextual event types and actual specific contexts, a machined-learned model can be generated to make predictions about end-user behavior when presented with future follow recommendations.

Finally, during the third phase, upon receiving a request for follow recommendations to be presented to a particular member, the previously stored, personal, follow recommendations for that member are retrieved, ranked, and eventually presented to the particular member. More precisely, some number of offline follow recommendations and their respective scores are selected, and to the extent that the end-user has taken action consistent with a particular contextual event, contextual follow recommendations consistent with the context, and their respective scores, are selected. The offline and contextual follow recommendations are then ordered based on their respective scores and presented to the end-user ordered in accordance with their respective scores.

As shown in FIG. 4, the offline portion of the follow recommendation engine 302-B includes a scoring model generator 400, a candidate selection engine 402 and a feature extraction engine 404. During the first phase—the training phase—the candidate selection engine 402 will randomly select a set of members to whom a set of follow recommendations are to be presented. As opportunities arise to present the follow recommendations to the members in the randomly selected set of members, the responses those members have to the follow recommendations are monitored and stored. For example, if a member chooses to follow a recommended entity—a positive response—this member response information is stored for use in training a relevant scoring model. If a member views a follow recommendation but takes no action—a negative response—this member response information is also stored for use in training the relevant scoring model. Additionally, characteristics of the member (features, for use in machine learning algorithms) are tracked for use in correlating a set of member characteristics with member behavior, and ultimately predicting future member behavior. In this manner, training data for both offline and contextual prediction models are obtained.

Similarly, for some period of time subsequent to a member creating a new follow edge by electing to follow a recommended entity, that member's interactions with content presented in connection with the new follow edge will be monitored. If a member exhibits any of a variety of positive interactions with content associated with a new follow edge, these positive interactions are monitored and stored for subsequent use in generating a relevant scoring model. By way of example, a positive interaction with content might be any of the following: selecting a content item to view, commenting on a content item, sharing a content item, and/or up-voting or “liking” a content item. Of course, negative interactions generally consist of viewing a content item, but not taking any action. This member engagement information is stored for subsequent use in training one or more additional machine-learned scoring models for use in predicting when a member will engage with content—and, to what extent (e.g., the number of interactions)—when content is presented in connection with a newly formed follow edge.

After a sufficient number of follow recommendations have been presented to the randomly selected set of members, and a sufficient amount of response information and engagement information have been observed (and stored), the scoring model generator 400 uses the member response information and the engagement information to train the corresponding scoring models (408, 410, 411, 413), respectively. With some embodiments, first and second scoring models (e.g., 408 and 410) may be generated for the purpose of offline follow recommendations, while additional scoring models (e.g., 411 and 413) may be trained for each of a plurality of different contexts. While only two contextual scoring models are shown in FIG. 3, in various embodiments, any number of additional contextual scoring models may be generated for scoring follow recommendations that are associated with different contexts. For instance, a context may involve a member having just recently followed another member. A separate scoring model may be trained to score contextual follow recommendations for this particular context and contextual event.

With some embodiments, linear regression modeling is performed to generate predictive models from the observed data (e.g., the member response information). Accordingly, the result of training the a scoring model may be a linear equation that combines a specific set of input values (e.g., features), with learned scaling factors (e.g., coefficients), the solution to which is the predicted output that is, a score that represents the likelihood that a follow recommendation will be selected by the member, resulting in a new follow edge. With some embodiments, a scoring model for use in predicting the level of engagement a member will exhibit with a newly formed follow edge is derived in a similar manner, but using a log linear regression model and with different input values (e.g., features). Accordingly, a scoring model based on log linear regression model may predict a total number of anticipated actions that a member may have with content that is published by, or on behalf of, the entity associated with the newly formed follow edge. Of course, other techniques are possible and within the realm of the inventive subject matter.

During the second phase—the candidate scoring phase the candidate selection engine 402 will use broad heuristics to select a set of follow recommendation candidates for each member in some set of members. For a given member and follow recommendation candidate pair, the feature extraction engine 404 will request and obtain relevant features for use in scoring the follow recommendation candidate using the predictive, machine-teamed scoring models that were generated during the first phase. The features may be requested from any number and variety of data sources but will generally be data attributes or member characteristics relating to the profiles of the member and the entity being recommended, and relevant interaction or activity data. A first set of features is provided as input to the candidate scoring engine 406, which uses the scoring model 408 to derive a first score, representing a likelihood that the member will choose to follow the follow recommendation candidate when presented with the follow recommendation. Similarly, using a second set of features obtained by the feature extraction engine 404, the candidate scoring engine 406 feeds the second set of features as input to the second scoring model (e.g., 410), for generating a score representative of the likelihood that the member will engage with content presented by, or on behalf of, the recommended entity, during some period of time immediately subsequent to the formation of a new follow edge. Finally, the first score and second score are combined in some manner—for example, by taking the product of the two scores in some instances—to generate a follow recommendation score for the follow recommendation. As the scoring model for predicting engagement may output a number that is representative of the predicted number of interactions that are expected to occur, a sigmoid function may be used to convert or map the number to a probability, prior to combining the score with that generated by the first scoring model (e.g., the linear regression model). This process of generating and storing follow recommendations (e.g., candidates and corresponding scores) is repeated for each member in some set of members until each member has a sufficient number of scored follow recommendation candidates stored (e.g., as follow recommendations data 312). Furthermore, this process is completed for both offline follow recommendations—those that are not dependent upon any specific context—and, for any number and variety of contextual follow recommendations, associated with various contexts.

During the third phase—the online or real-time phase—a member, using a client application 414 executing on a client device, will navigate to an interface (es., web page, or similar), causing a request to be communicated for a set of follow recommendations for the viewing member. Upon receiving the request, a request handler 416 will initiate a series of parallel requests for information. Specifically, using some information (e.g., a member identifier, or, ID) received with the request and identifying the particular member for whom follow recommendations are being requested, a set of offline follow recommendations for the member are obtained (e.g., from the follow recommendation data 412). Additionally, the request handler 416 will make a call to a context service 417 to obtain information about any actions or interactions that the member may have taken that are consistent with any contexts for which contextual follow recommendations are available. The context service 417 will return a set of context identifiers, if applicable. Using the context identifiers and the member identifier, the database 412 is again queried for contextual follow recommendations.

Separately, the request handier 416 will request profile information 418, follow edges 420 and connection edges 422 for the particular member, and privacy settings 424 for those entities for which a follow recommendation is received. The profile information, follow edges, connection edges and privacy setting information are provided as input to the filtering module 426, which uses the information to filter the obtained follow recommendations, e.g., thereby excluding any follow recommendations associated with entities that the particular member is already following, or with which the member has recently established a connection, or, for which the privacy settings are inconsistent with presentation of a follow recommendation. This is done to avoid making a follow recommendation for an entity that the member is already following, or for an entity to which the member is already connected, or for an entity that has expressed not to be recommended.

In addition, consistent with some embodiments, the profile information may include information about follow recommendations that were previously presented to the member. At least with some embodiments, there is a preference to avoid showing a member the same follow recommendation(s) over and over again, particularly when the member has viewed the follow recommendation and not acted—e.g., followed the entity being recommended. Accordingly, the impression discounting module 428 will apply a discount to the final follow recommendation score of any follow recommendation that the member has previously viewed. With some embodiments, the discount factor may vary with time, such that those follow recommendations more recently viewed are more heavily discounted, and so forth. By discounting the follow recommendation scores with an impression discounting factor, those follow recommendations previously viewed by the member are assigned lower overall scores, and are thus less likely to be presented to the member, or if presented, will be lower in order (e.g., less prominently positioned on the interface).

Finally, the re-ranking module 430 will rank the follow recommendations based on their adjusted follow recommendation scores. With some embodiments, the scores that are associated with each follow recommendation are not final scores, but a set of sub-scores. In this way, a score that is specific to a context can be combined to a score that is specific to the viewer, and/or a score that is specific to a particular entity being recommended. By retrieving the sub-scores in real time and combining the sub-scores in real-time, duplicate processing is eliminated and fewer overall database calls are required, making the score calculation process faster and generally more pleasant for the end-user. Finally, once the final recommendation scores are determined, some subset—e.g., the top “N” ranked—follow recommendations are then returned to the requesting client 414 for presentation to the member. The final subset of recommendations returned to the viewing member may include just offline follow recommendations, just contextual follow recommendations, or some combination of both, depending upon the final follow recommendation scores.

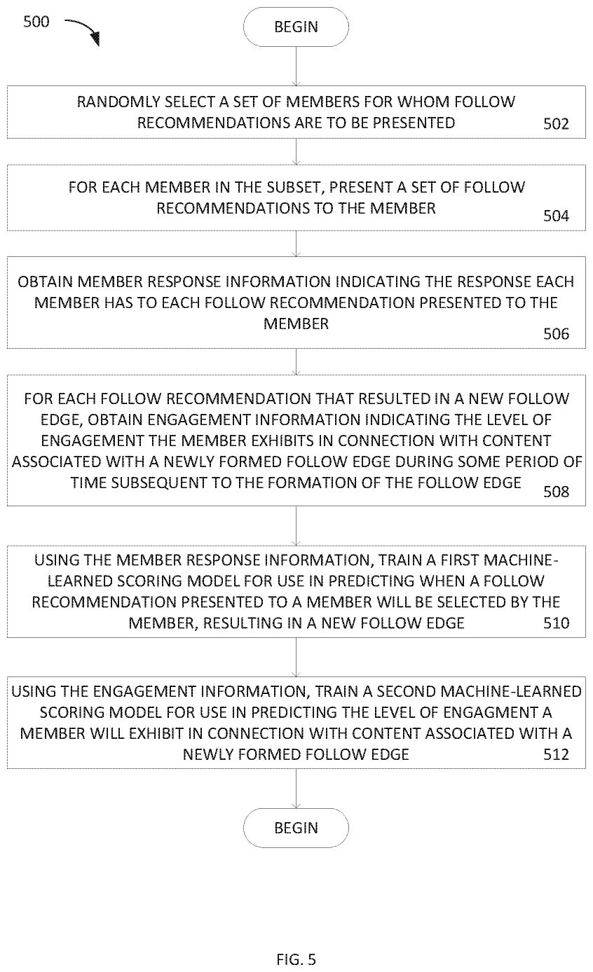

FIG. 5 is a flow diagram illustrating a method of obtaining training data and learning, via machine-learning techniques, a scoring model for scoring follow recommendations for members of a social networking service, consistent with embodiments of the present invention. As shown in FIG. 5, the method 500 begins when, at operation 502, a set of members are randomly selected to have follow recommendations presented to the members, in part for the purpose of obtaining training data. At method operation 504, for a member in the randomly selected set of members, a set of follow recommendations is presented. The presentation of the set of follow recommendations may occur in a single interface dedicated to the presentation of follow recommendations. Alternatively, individual follow recommendations may be presented to the member in a serial manner via some other interface or application, such as in a feed or news feed. In any case, each member in the randomly selected set of members is presented with multiple follow recommendations over some period of time. During that time, as shown with reference number 506, member response data is obtained, where the member response information indicates the response that each member has to the presentation of a particular follow recommendation. Selection of a follow recommendation is recorded as a positive response, whereas, viewing but not selecting a follow recommendation is recorded as a negative response. In the particular case of contextual follow recommendations, the training data may be obtained by presenting follow recommendations to members immediately subsequent to those members having taken some action consistent with a contextual event. For instance, instead of presenting follow recommendations to some random set of members, follow recommendations may he presented to members after they follow a particular entity, or, view the profile of a particular entity, and so forth.

Next, at method operation 508, for each follow recommendation that is associated with a positive response and the formation of a new follow edge, during some time period subsequent to the formation of the new follow edge, a member's engagement with content associated with the new follow edge is observed. For instance, if the member interacts with content (e.g., likes the content, shares the content, or makes a comment regarding the content, etc.) that has been posted by another newly followed member, the interaction is recorded as a positive response or interaction. Similarly, if a member views, but does not take action on some content associated with a new follow edge, the lack of any interaction or engagement with respect to the content is recorded as a negative response.

At method operation 510, using the member response information, a machine-learned scoring model is generated for use in predicting when a follow recommendation presented to a member will be selected, resulting in a new follow edge. With some embodiments, the scoring model is based on linear regression, such that the resulting model is a linear equation with learned coefficients that map to various feature values, and the combination of coefficients and feature values is a single value representing a probability that a member will select a follow recommendation, or, in the case of contextual follow recommendations, select a follow recommendation subsequent to engaging in an act consistent with the context.

At method operation 512, using the member engagement information that was obtained (e.g., during method operation 508), a machine-learned scoring model is trained for use in predicting the level of engagement a member will exhibit with content associated with a new follow edge, during some time period immediately subsequent to the formation of the new follow edge. This model for predicting engagement may be based on logistic regression, such that the resulting equation is non-linear, and the single output is mapped to a probability using a sigmoid function. In any case, scoring models are stored for subsequent use in scoring offline and contextual follow recommendations as appropriate. With some embodiments, the scoring models are periodically updated, using additional training data that may be obtained over some period of time.

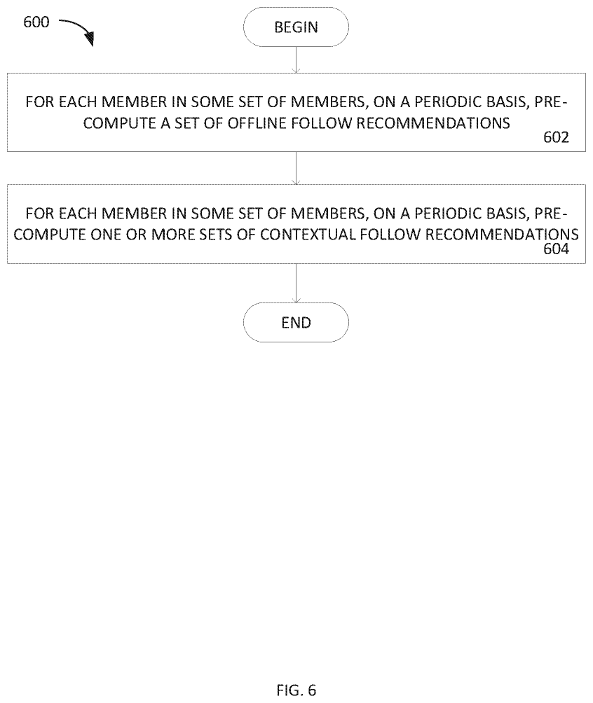

FIG. 6 is a flow diagram illustrating a method, performed offline, of scoring follow recommendations on a per member basis, using machine-learned scoring models, consistent with embodiments of the invention. Once the various scoring models for offline and contextual follow recommendations are generated, follow recommendations for each member in some population of members are scored and stored for subsequent recall and presentation to the respective members. For example, as indicated with reference number 602, for each member in some population of members for whom follow recommendations are to be generated and presented, some broad heuristics are used to first identify a set of offline follow recommendation candidates for each member. As an example, the candidate entities may be selected based on how many existing followers the candidate entities currently have.

For a particular member and offline follow recommendation candidate pair, different sets of features are obtained from the respective profiles of the member and the entity to which the follow recommendation pertains, and certain features relating to the member and entity pair—e.g., such as features relating to interactions that the member has had with the entity, and so forth. With some embodiments, the features may be obtained from any one of several different data sources, and may include, in addition to traditional profile attributes and characteristics, information relating to the activities and interactions that the member, and in some instances, a member being recommended, have taken. Similarly, the features may include information about other members who have interacted with the entity being recommended, and/or the member to whom the follow recommendation is to be presented. In any case, as part of the feature extraction process, some data manipulation may occur to prepare and format the input data for use with the scoring model and scoring engine. For example, with some embodiments, the dimensionality of the data may be reduced, and one or more feature vectors may be generated to make the scoring operation more resource and computationally efficient.

For each member and follow recommendation candidate pair, a scoring model is used to calculate a first score that represents the likelihood that the member, if and when presented with a follow recommendation corresponding to the entity of the follow recommendation candidate, will elect to follow the entity being recommended. Additionally, with sonic embodiments, another scoring model is used to calculate a second score that represents a measure of how likely the member is to engage with content that is published by, on behalf of, or otherwise in association with, the entity being recommended. Finally, the first and second scores are combined to derive a final offline follow recommendation utility score for the offline follow recommendation candidate. The offline follow recommendation candidate and corresponding follow recommendation score are written to a database for subsequent recall. This process is repeated for some suitable number of follow recommendation candidates, for each member in the population of members for whom follow recommendations are to be presented.

Next, at operation 604, for each member in the population of members, one or more sets of contextual follow recommendations are generated and stored. Similar to how offline follow recommendations are generated, the contextual follow recommendations are generated by first using some broad heuristic to select candidates, then obtaining the necessary features to score the candidates, and finally scoring the candidates with scoring models that are specific to a particular context. The end result is a set of personalized, scored contextual follow recommendations that are associated with specific contexts (e.g., context identifiers).

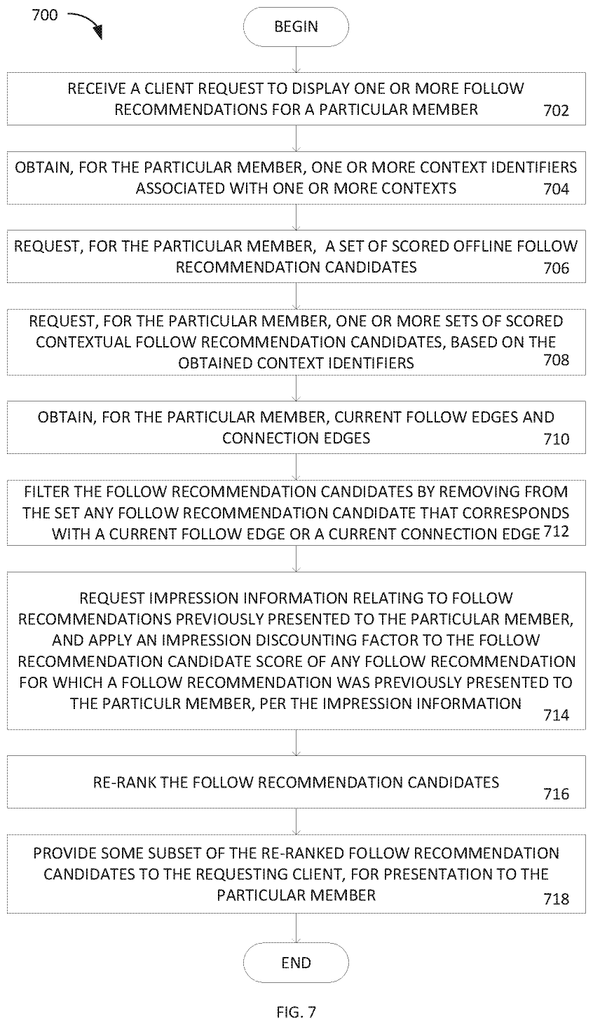

FIG. 7 is a flow diagram illustrating a method, performed online or in real-time, for ranking and presenting follow recommendations, responsive to a request and consistent with embodiments of the present invention. At method operation 702, a request is received for follow recommendations to be presented to a particular member. The request may identify the member, e.g., by including in the request a member identifier (ID). At method operation 704, context information for the member is obtained. For example, with some embodiments, using the member ID, a call is made to a context service that will return one or more context identifiers if the member has taken any actions that are consistent with contexts corresponding to those context identifiers. As an example, a call to the context service may result in the return of a context identifier that indicates the member has recently viewed another specific member's profile, or, just recently followed another specific member, and so forth.

At method operation 706, a request or query is communicated to a data store that is storing precomputed offline follow recommendations and corresponding follow recommendations scores, for the particular member. At method operation 708, using the context identifiers that were obtained at operation 704, a data store is queried to obtain scored, contextual follow recommendations that correspond with the context identifiers.

At method operation 710, the current follow edges and connection edges for the particular member are obtained. The current follow edges and connection edges identify the members that particular member is already following, and/or with whom the member is already connected via the social networking service. Accordingly, at method operation 712, those follow recommendations (both offline and contextual) associated with an entity that, according to the current follow edges and connection edges, the member is already following or with which the member is already connected, are filtered out so that the entities are not presented as follow recommendations.

Next, at operation 714, impression information relating to the follow recommendations that the member has previously viewed is obtained and used in discounting the follow recommendation scores of any follow recommendation that has previously been viewed by the member. The value of any discount factor may be in direct correlation with the number of times a particular recommendation has been presented to a member, and/or the amount of time that has lapsed since the recommendation was last presented to the member. Any number of time decay algorithms may be used to derive the discount factor. Finally, the follow recommendations are re-ranked at method operation 716, consistent with their adjusted follow recommendation scores, and provided to the requesting application or service at method operation 718, for ultimate presentation to the member.

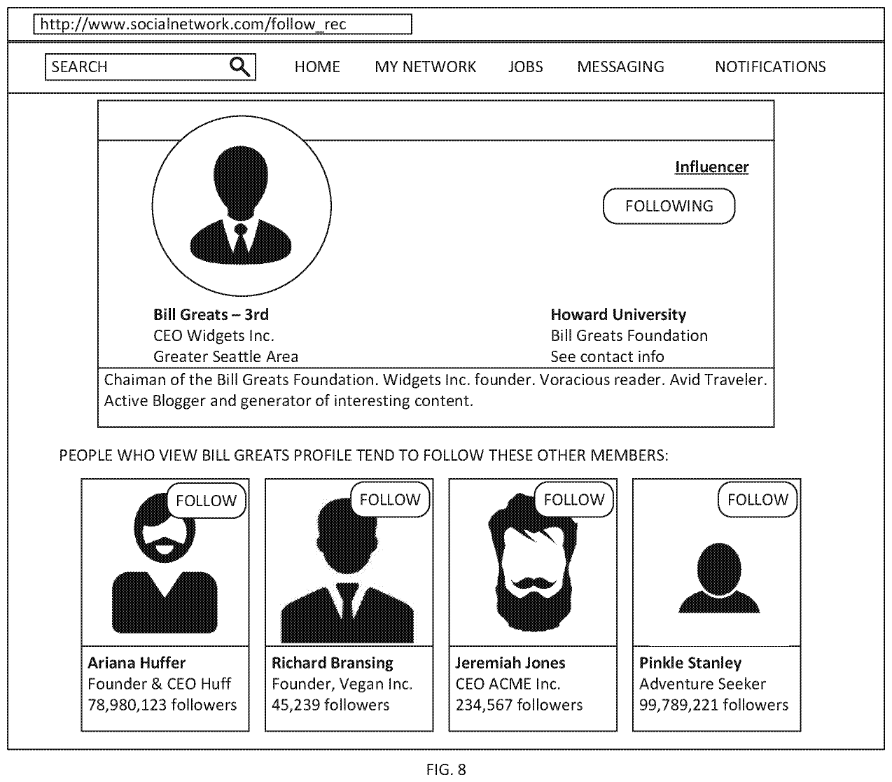

FIG. 8 is a user interface diagram showing an example of a set of top ranked follow recommendations, including contextual follow recommendations, being presented to a member who has taken an action consistent with a particular context. In this example, the viewing member is viewing a member profile for another member, Bill Greats. In this case, a set of contextual follow recommendations exist for the contextual event that corresponds with viewing the profile of the member, Bill Greats. Accordingly, in addition to presenting the profile of Bill Greats, a set of follow recommendations are presented. The follow recommendations are those highest ranked follow recommendations after combining the offline and contextual follow recommendations that have been pre-computed for the member, based on the particular context.

While many of the particular examples presented herein are described in the context of a social networking service or system, skilled artisans will readily appreciate the applicability of the inventive subject matter to other domains. Furthermore, in some examples presented herein, the term “browsing” is used with reference to an end-user consuming content—for example, navigating to and viewing web pages with a web browser application. However, the term “browsing” should be broadly construed to include viewing content via any number and variety of applications—including applications native to any number of mobile computing platforms. For purposes of the present disclosure, contextual information is information that indicates the type of content that an end-user has interacted with, but also the day or time at which an interaction occurred, and/or information about the computing device (e.g., mobile phone, desktop computer) in use when interacting with the content. Although other context types are possible, at least with some embodiments, the following context types are considered: an end-user has recently followed an entity (e.g., a member, a company, a topic or channel); an end-user has recently viewed the profile of an entity; an end-user has recently viewed an article, or other content; the day of the week or month, and/or time of the day; and/or, the type of computing device (e.g., mobile device or desktop device, operating system, and so forth) on which the interaction occurred.

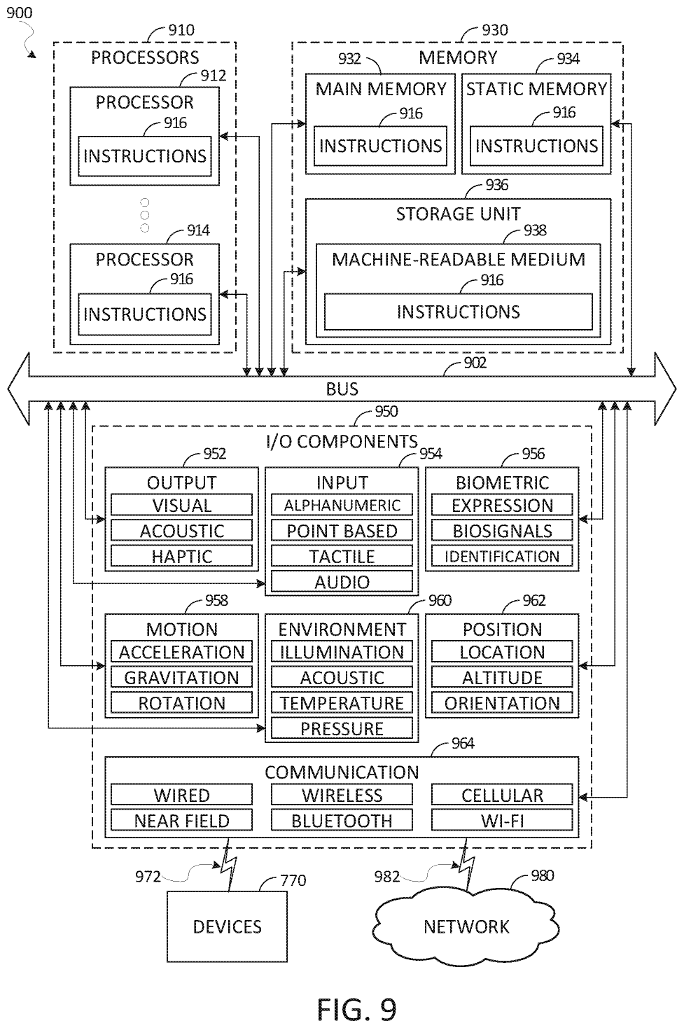

FIG. 9 illustrates a diagrammatic representation of a machine 900 in the form of a computer system within which a set of instructions may be executed for causing the machine to perform any one or more of the methodologies discussed herein, according to an example embodiment. Specifically, FIG. 9 shows a diagrammatic representation of the machine 900 in the example form of a computer system, within which instructions 916 (e.g., software, a program, an application, an apples, an app, or other executable code) for causing the machine 900 to perform any one or more of the methodologies discussed herein may be executed. For example the instructions 916 may cause the machine 900 to execute any one of the methods 400, 500, or 600. Additionally, or alternatively, the instructions 916 may implement the systems described in connection with any of FIGS. 2 or 3, and so forth. The instructions 916 transform the general, non-programmed machine 900 into a particular machine 900 programmed to carry out the described and illustrated functions in the manner described. In alternative embodiments, the machine 900 operates as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a PC, a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 916, sequentially or otherwise, that specify actions to be taken by the machine 900. Further, while only a single machine 900 is illustrated, the to “machine” shall also be taken to include a collection of machines 900 that individually or jointly execute the instructions 916 to perform any one or more of the methodologies discussed herein.

The machine 900 may include processors 910, memory 930, and I/O components 950, which may be configured to communicate with each other such as via a bus 902. In an example embodiment, the processors 910 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RTIC), another processor, or any suitable combination thereof) may include, for example, a processor 912 and a processor 914 that may execute the instructions 916. The term “processor” is intended to include multi-core processors that may comprise two or more independent processors (sometimes referred to as “cores”) that may execute instructions contemporaneously. Although FIG. 9 shows multiple processors 910, the machine 900 may include a single processor with a single core, a single processor with multiple cores (e.g., a multi-core processor), multiple processors with a single core, multiple processors with multiples cores, or any combination thereof.

The memory 930 may include a main memory 932, a static memory 934, and a storage unit 936, all accessible to the processors 910 such as via the bus 902. The main memory 930, the static memory 934, and storage unit 936 store the instructions 916 embodying any one or more of the methodologies or functions described herein. The instructions 916 may also reside, completely or partially, within the main memory 932, within the static memory 934, within the storage unit 936, within at least one of the processors 910 (e.g., within the processor's cache memory), or any suitable combination thereof, during execution thereof by the machine 900.

The I/O components 950 may include a wide variety of components to receive input, provide output, produce output, transmit information, exchange information, capture measurements, and so on. The specific 110 components 950 that are included in a particular machine will depend on the type of machine. For example, portable machines such as mobile phones will likely include a touch input device or other such input mechanisms, while a headless server machine will likely not include such a touch input device. It will be appreciated that the I/O components 950 may include many other components that are not shown in FIG. 9. The I/O components 950 are grouped according to functionality merely for simplifying the following discussion and the grouping is in no way limiting. In various example embodiments, the I/O components 950 may include output components 952 and input components 954. The output components 952 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 954 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 950 may include biometric components 956, motion components 958, environmental components 960, or position components 962, among a wide array of other components. For example, the biometric components 956 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 758 may include acceleration sensor components (e.g., accelerometer), gravitation sensor components, rotation sensor components (e.g., gyroscope), and so forth. The environmental components 760 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 962 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 950 may include communication components 964 operable to couple the machine 900 to a network 980 or devices 970 via a coupling 982 and a coupling 972, respectively. For example, the communication components 964 may include a network interface component or another suitable device to interface with the network 980. In further examples, the communication components 964 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 970 may be another machine or any of a wide variety of peripheral devices (e.g., a peripheral device coupled via a USB).

Moreover, the communication components 964 may detect identifiers or include components operable to detect identifiers. For example, the communication components 964 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (es., microphones to identify tagged audio signals). In addition, a variety of information may be derived via the communication components 764, such as location via Internet Protocol (IP) geolocation, location via Wi-Fi® signal triangulation, location via detecting an NFC beacon signal that may indicate a particular location, and so forth.

### Executable Instructions and Machine Storage Medium

The various memories (i.e., 930, 932, 934, and/or memory of the processor(s) 910) and/or storage unit 936 may store one or more sets of instructions and data structures (e.g., software) embodying or utilized by any one or more of the methodologies or functions described herein. These instructions (e.g., the instructions 916), when executed by processor(s) 910, cause various operations to implement the disclosed embodiments.

As used herein, the terms “machine-storage medium,” “device-storage medium,” “computer-storage medium” mean the same thing and may be used interchangeably in this disclosure. The temis refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Transmission Medium

In various example embodiments, one or more portions of the network 980 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 980 or a portion of the network 980 may include a wireless or cellular network, and the coupling 982 may be a Code Division Multiple Access (CDMA) connection, a Global System for Mobile communications (GSM) connection, or another type of cellular or wireless coupling. In this example, the coupling 982 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 916 may be transmitted or received over the network 980 using a transmission medium via a network interface device (e.g., a network interface component included in the communication components 964) and utilizing any one of a number of well-known transfer protocols (e.g., HTTP). Similarly, the instructions 916 may be transmitted or received using a transmission medium via the coupling 972 (e.g., a peer-to-peer coupling) to the devices 070. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 916 for execution by the machine 900, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

### Computer-Readable Medium

The terms “machine-readable medium,” “computer-readable medium” and “device-readable medium” mean the same thing and may be used interchangeably in this disclosure. The temis are defined to include both machine-storage media and transmission media. Thus, the temis include both storage devices/media and carrier waves/modulated data signals.

What is claimed is:

1. A method for generating and presenting contextual follow recommendations, the method comprising:
for each member of a plurality of members, on a periodic basis, pre-compute a set of offline follow recommendations by i) identifying a set of offline follow recommendation candidates, ii) scoring each offline follow recommendation candidate in the set of offline follow recommendation candidates using one or more machine-learned scoring models, and iii) storing the follow recommendation candidates and their corresponding scores in a database;
for each member of the plurality of members, on a periodic basis, pre-compute a set of contextual follow recommendations by i) identifying a set contextual follow recommendation candidates for a specific context, ii) scoring each contextual follow recommendation candidate in the set of contextual follow recommendation candidates using one or more machine-learned scoring models associated with the specific context, and iii) storing, in the database, the contextual follow recommendation candidates, their corresponding scores, and a context identifier associated with the specific context;
subsequent to pre-computing the set of offline follow recommendations and subsequent to pre-computing the set of contextual follow recommendations, processing a request for follow recommendations for a particular member by i) obtaining, for the particular member, one or more context identifiers associated with one or more contexts, ii) using the one or more context identifiers, querying the database for a set of contextual follow recommendations related to contexts associated with the one or more context identifiers, iii) querying the database for a set of offline follow recommendations, and iv) using their respective scores, ranking the contextual follow recommendations and the offline follow recommendations to derive a ranked set of follow recommendations; and
providing the ranked set of follow recommendations to an application or service from which the request for follow recommendations was received, thereby enabling presentation of some subset of the ranked set of follow recommendations to the particular member.

2. The method of claim 1, wherein each context identifier is associated with a context, and said step of obtaining, for the particular member, one or more context identifiers associated with one or more contexts comprises:
determining that the particular member has taken an action consistent with a context, the action being one of: a member has recently followed a particular entity; a member has recently viewed the profile of a particular entity; and, a member has recently viewed a particular article, or an article associated with a particular topic.

3. The method of claim 1, wherein scoring each offline follow recommendation candidate in the set of offline follow recommendation candidates using one or more machine-learned scoring models comprises:
deriving, for each offline follow recommendation candidate, a first score by providing a first set of features as input to a first machine-learned scoring model for predicting when an offline follow recommendation presented to a member will be selected by the member, resulting in formation of a new follow edge;
deriving, for each offline follow recommendation candidate, a second score by providing a second set of features as input to a second machine-learned scoring model for predicting a level of engagement a member will exhibit in connection with content associated with the newly formed follow edge; and
for each contextual follow recommendation candidate, combining the first score and the second score to derive a final follow recommendation score.

4. The method of claim 3, wherein the first machine-learned scoring model is based on a logistic regression model having a set of inputs and a single output, the single output representing a metric for predicting when an offline follow recommendation presented to a member will be selected by the member, resulting in formation of a new follow edge, and the second machine-learned scoring model is based on log-linear regression having a set of inputs and a single output representing a level of predicted engagement the member will have with content published by, or on behalf of, an entity being recommended.

5. The method of claim 1, wherein scoring each contextual follow recommendation candidate in the set of contextual follow recommendation candidates using one or more machine-learned scoring models comprises:
deriving, for each contextual follow recommendation candidate for a specific context, a first score by providing a first set of features as input to a first machine-learned scoring model for predicting when a contextual follow recommendation presented to a member will be selected by the member, resulting in fauna:lion of a new follow edge;
deriving, for each offline contextual recommendation candidate for a specific context, a second score by providing a second set of features as input to a second machine-learned scoring model for predicting a level of engagement a member will exhibit in connection with content associated with the newly formed follow edge; and
for each contextual follow recommendation candidate, combining the first score and the second score to derive a final follow recommendation score.

6. The method of claim 5, wherein the first machine-learned scoring model is based on a logistic regression model having a set of inputs and a single output, the single output representing a metric for predicting when a contextual follow recommendation presented to a member will be selected by the member, resulting in formation of a new follow edge, and the second machine-learned scoring model is based on log-linear regression having a set of inputs and a single output representing a level of predicted engagement the member will have with content published by, or on behalf of, an entity being recommended.

7. The method of claim 1, wherein ranking the contextual follow recommendations and the offline follow recommendations to derive a ranked set of follow recommendations comprises:
for each offline follow recommendation, combining a set of sub-scores to derive a final follow recommendation score;
for each contextual follow recommendation, combining a set of sub-scores to derive a final follow recommendation score; and
select from the offline follow recommendations and the contextual follow recommends some predetermined number of follow recommendations having the highest follow recommendation scores.

8. The method of claim 7, further comprising:
prior to ranking the contextual follow recommendations and the offline follow recommendations to derive a ranked set of follow recommendations, obtaining infounation identifying entities the particular member has elected to follow and entities with whom the member has connected since the offline recommendations and the contextual recommendations were last derived for the particular member; and
excluding from the ranked set of follow recommendations any follow recommendation associated with an entity the member is following and/or with whom the member has connected.

9. The method of claim 1, wherein scoring each contextual follow recommendation candidate in the set of contextual follow recommendation candidates using one or more machine-learned scoring models comprises:
providing as input to various machine-learned scoring models different sets of features, wherein a first set of features includes features that are related to an entity being recommended, a second set of features includes features related to a member to whom a contextual follow recommendation is to be presented, and a third set of features includes features related to a pairing of the entity being recommended and the member to whom a contextual follow recommendation is to be presented.

10. A system comprising:
a computer-readable storage medium having instructions stored thereon, which, when executed by a processor, cause the system to:
for each member of a plurality of members, on a periodic basis, pre-compute a set of offline follow recommendations by i) identifying a set of offline follow recommendation candidates, scoring each offline follow recommendation candidate in the set of offline follow recommendation candidates using one or more machine-learned scoring models, and iii) storing the follow recommendation candidates and their corresponding scores in a database;
for each member of the plurality of members, on a periodic basis, pre-compute a set of contextual follow recommendations by i) identifying a set contextual follow recommendation candidates for a specific context, ii) scoring each contextual follow recommendation candidate in the set of contextual follow recommendation candidates using one or more machine-learned scoring models associated with the specific context, and iii) storing, in the database, the contextual follow recommendation candidates, their corresponding scores, and a context identifier associated with the specific context;
subsequent to pre-computing the set of offline follow recommendations and subsequent to pre-computing the set of contextual follow recommendations, process a request for follow recommendations for a particular member by i) obtaining, for the particular member, one or more context identifiers associated with one or more contexts, ii) using the one or more context identifiers, querying the database for a set of contextual follow recommendations related to contexts associated with the one or more context identifiers, iii) querying the database for a set of offline follow recommendations, and iv) using their respective scores, ranking the contextual follow recommendations and the offline follow recommendations to derive a ranked set of follow recommendations; and
provide the ranked set of follow recommendations to an application or service from which the request for follow recommendations was received, thereby enabling presentation of some subset of the ranked set of follow recommendations to the particular member.

11. The system of claim 11, wherein each context identifier is associated with a context, the system further comprising:
additional instructions, which, when executed by the processor, cause the system to determine that the particular member has taken an action consistent with a context, the action being one of: a member has recently followed a particular entity; a member has recently viewed the profile of a particular entity; and, a member has recently viewed a particular article, or an article associated with a particular topic.

12. The system of claim 10, further comprising:
additional instructions, which, when executed by the processor, cause the system to derive, for each offline follow recommendation candidate, a first score by providing a first set of features as input to a first machine-learned scoring model for predicting when an offline follow recommendation presented to a member will be selected by the member, resulting in formation of a new follow edge;
derive, for each offline follow recommendation candidate, a second score by providing a second set of features as input to a second machine-learned scoring model for predicting a level of engagement a member will exhibit in connection with content associated with the newly formed follow edge; and
for each contextual follow recommendation candidate, combine the first score and the second score to derive a final follow recommendation score.

13. The system of claim 12, wherein the first machine-learned scoring model is based on a logistic regression model having a set of inputs and a single output, the single output representing a metric for predicting when an offline follow recommendation presented to a member will be selected by the member, resulting in formation of a new follow edge, and the second machine-learned scoring model is based on log-linear regression having a set of inputs and a single output representing a level of predicted engagement the member will have with content published by, or on behalf of, an entity being recommended.

14. The system of claim 10, further comprising:
additional instructions which, when executed by the processor, cause the system to:
derive, for each contextual follow recommendation candidate for a specific context, a first score by providing a first set of features as input to a first machine-learned scoring model for predicting when a contextual follow recommendation presented to a member will be selected by the member, resulting in formation of a new follow edge;
derive, for each offline contextual recommendation candidate for a specific context, a second score by providing a second set of features as input to a second machine-learned scoring model for predicting a level of engagement a member will exhibit in connection with content associated with the newly formed follow edge; and
for each contextual follow recommendation candidate, combine the first score and the second score to derive a final follow recommendation score.

15. The system of claim 14, wherein the first machine-learned scoring model is based on a logistic regression model having a set of inputs and a single output, the single output representing a metric for predicting when a contextual follow recommendation presented to a member will be selected by the member, resulting in formation of a new follow edge, and the second machine-learned scoring model is based on log-linear regression having a set of inputs and a single output representing a level of predicted engagement the member will have with content published by, or on behalf of, an entity being recommended.

16. The system of claim 10, further comprising:
additional instructions, which, when executed by the processor, cause the system to:
for each offline follow recommendation, combine a set of sub-scores to derive a final follow recommendation score;
for each contextual follow recommendation, combine a set of sub-scores to derive a final follow recommendation score; and
select from the offline follow recommendations and the contextual follow recommends some predetermined number of follow recommendations having the highest follow recommendation scores.

17. The system of claim 16, further comprising:
additional instructions, which, when executed by the processor, cause the system to:
prior to ranking the contextual follow recommendations and the offline follow recommendations to derive a ranked set of follow recommendations, obtain information identifying entities the particular member has elected to follow and entities with whom the member has connected since the offline recommendations and the contextual recommendations were last derived for the particular member; and
exclude from the ranked set of follow recommendations any follow recommendation associated with an entity the member is following and/or with whom the member has connected.

18. The system of claim 10, further comprising:
additional instructions, which, when executed by the processor, cause the system to:
provide as input to various machine-learned scoring models different sets of features, wherein a first set of features includes features that are related to an entity being recommended, a second set of features includes features related to a member to whom a contextual follow recommendation is to be presented, and a third set of features includes features related to a pairing of the entity being recommended and the member to whom a contextual follow recommendation is to be presented.

19. A method for generating and presenting contextual follow recommendations, the method comprising:
for each member of the plurality of members, on a periodic basis, pre-compute a set of contextual follow recommendations by i) identifying a set contextual follow recommendation candidates for a specific context, ii) scoring each contextual follow recommendation candidate in the set of contextual follow recommendation candidates using one or more machine-learned scoring models associated with the specific context, and iii) storing, in the database, the contextual follow recommendation candidates, their corresponding scores, and a context identifier associated with the specific context;
subsequent to pre-computing the set of contextual follow recommendations, processing a request for follow recommendations for a particular member by i) obtaining, for the particular member, one or more context identifiers associated with one or more contexts, ii) using the one or more context identifiers, querying the database for a set of contextual follow recommendations related to contexts associated with the one or more context identifiers, and iv) using their respective scores, ranking the contextual follow recommendations to derive a ranked set of follow recommendations; and
providing the ranked set of follow recommendations to an application or service from which the request for follow recommendations was received, thereby enabling presentation of some subset of the ranked set of follow recommendations to the particular member.

20. The method of claim 19, wherein each context identifier is associated with a context, and said step of obtaining, for the particular member, one or more context identifiers associated with one or more contexts comprises:
determining that the particular member has taken an action consistent with a context, the action being one of: a member has recently followed a particular entity; a member has recently viewed the profile of a particular entity; and, a member has recently viewed a particular article, or an article associated with a particular topic.
